(19) United States
(12) Patent Application Publication
(10) Pub. No.: US 2016/0066733 A1
(43) Pub. Date: Mar. 10, 2016

(54) SYSTEM FOR THE SELECTIVE RECEIPT OF DELIVERED PARCELS UTILIZING A LOCK BOX HAVING AUTOMATED AND REMOTELY CONTROLLED FEATURES

(71) Applicant: John Gozar, Jupiter, FL (US)

(72) Inventor: John Gozar, Jupiter, FL (US)

(21) Appl. No.: 14/847,728

(22) Filed: Sep. 8, 2015

Related U.S. Application Data
(60) Provisional application No. 62/048,557, filed on Sep. 10, 2014.

(51) Int. Cl. A47G 29/122; G06Q 10/08

(52) U.S. Cl. CPC A47G 29/1225; G06Q 10/0833; A47G 2029/1226

(57) ABSTRACT

A parcel delivery system is provided, comprising a lock box comprising a door providing access to a storage space, an electrically operated door locking mechanism, and a parcel scanning device. The system also provides a memory configured to store computer-readable code executable by a processor. The code comprises instructions for decoding a parcel tracking number scanned by the scanning device and determining if the tracking number is an authorized tracking number. If the tracking number is not an authorized tracking number, the door remains locked. If the tracking number is an authorized tracking number, the locking mechanism is enabled to unlock the door, whereby the door is allowed to be opened and the parcel placed into the storage space. After the door has been closed, the locking mechanism is enabled to lock the door. The code also comprises instructions to send messages to the recipient of the parcel.

### CROSS-REFERENCE TO RELATED APPLICATIONS

This Application claims the benefit of U.S. Provisional Application No. 62/048,557, having a filing date of Sep. 10, 2014 and is hereby incorporated by reference in its entirety.

### TECHNICAL FIELD

This invention relates generally to parcel delivery systems. More specifically this invention relates to parcel delivery systems utilizing a lock box. More specifically this invention relates to a system for the selective receipt of delivered parcels utilizing a lock box having automated and remotely controlled features.

### BACKGROUND OF THE INVENTION

In the current art, the delivery and receipt of delivered parcels can be a cumbersome experience for the recipient. This can include missing a delivery, failing to be present to sign for a parcel, having to travel to remote offices to recover undelivered parcels, and even theft of parcels from the recipients unsecured mail box or doorstep.

The current art also presents problems for carriers. In the event that a parcel cannot be left at a destination, the carrier usually has to attempt a second delivery, leave a notice, and shuttle the parcel to and from the carrier office. This creates inefficiency, wastes time, and increases costs relating to man hours and transportation.

In the applicant's experience, there is a need a new and useful system for the selective receipt of delivered parcels utilizing a lock box having automated and remotely controlled features which has benefits over the prior art including i) allowing selective control of the receipt of delivered parcels, ii) implementation of customizable parameters for accepting or declining receipt of said parcels, iii) not requiring the parcel recipient to be present at time of delivery, iv) contemporaneous and asynchronous remote authorization of parcel delivery, v) eliminating the need for missed deliveries and subsequent notification, vi) eliminating travel to and from mail sorting centers and offices, vii) real time electronic notifications to the recipient upon parcel delivery, viii) automatic generation of tracking receipts as parcels are scanned, and ix) secure locked storage of parcels while contained in the mailbox. The device of the present invention is believed to accomplish all of the foregoing objectives.

### SUMMARY OF THE INVENTION

The present invention provides a new and useful system for the selective receipt of delivered parcels utilizing a lock box having automated and remotely controlled features which has benefits over the prior art including allowing selective control of the receipt of delivered parcels, implementation of customizable parameters for accepting or declining receipt of said parcels, not requiring the parcel recipient to be present at time of delivery, contemporaneous and asynchronous remote authorization of parcel delivery, eliminating the need for missed deliveries and subsequent notification, eliminating travel to and from mail sorting centers and offices, real time electronic notifications to the recipient upon parcel delivery, automatic generation of tracking receipts as parcels are scanned, and secure locked storage of parcels while contained in the mailbox.

In one of the basic embodiments, the present invention comprises a lock box which can be a mailbox, locker, or other storage container. The said lock box further comprises a door and a locking mechanism which prohibits the opening of the door when locked. The invention further comprises an electronic mechanism with a receiver and a transmitter connected to a mechanical motor for the unlocking and locking of the locking mechanism. An optical or laser reader is present on the lock box for the scanning of bar codes or other parcel specific tracking indicia. A mechanical attaching means is attached to the lock box for the purposes of rigidly affixing the present invention to a structure, such as an accessible exterior wall of a home or other building.

When in use and in at least one embodiment of the present invention a parcel is received at a mail sorting center such as a post office. The parcel is then routed according to indicia such as zip code and delivered by way of courier vehicle and personnel to its final destination. According to the present invention, each parcel possesses a tracking number and a marker such as a bar code. Once at the delivery address, the courier personnel approaches the lock box of the present invention. Said lock box is empty, locked and in a “ready state” wherein it is able to receive parcels. The courier personnel then scans the tracking number by holding the parcel in front of the optical or laser reader present on the lock box. The electronic mechanism, which contains a power source and a processing means, then compares the tracking number of the parcel against protocol parameters programmed remotely by the recipient.

In the event the parcel is deemed to meet the parameter criteria, the delivery is accepted. In this instance the locking mechanism of the lock box unlocks thereby allowing the door of the lock box to open. The courier personnel deposits the parcel into the lock box. Once deposited the lock box door closes and the locking mechanism locks until the parcel is retrieved by the recipient.

In the alternative, if the parcel is deemed not to meet the parameters set by the recipient, the lock box remains closed. In that instance the courier personnel returns the parcel to the sorting center for later delivery or pick up.

According to the present invention, the recipient is able to remotely program and define parameter criteria for the acceptance and declination of parcels. This can include data relating to acceptable couriers, specific tracking numbers, and even daily time intervals. This is non-exhaustive and the number of criteria is alterable according to future updates to the processing means of the lock box.

In order to effectuate programming the parameters for the locking protocols, the recipient who is the owner of the lock box uses an interface like a web page or mobile phone app whereon she makes relevant selections. The processing means of the invention then receives the elected parameters by way of a wireless protocol like Wi-Fi or Bluetooth. It is also envisioned that the lock box can be integrated to a local or wide area network. This can be accomplished with wired and wireless connectivity means for communicating with the lock box.

The connectivity of the present invention can also be used to transmit information from the lock box to the recipient. This information can include tracking and delivery confirmation and real time requests for approval. In this way the recipient can remotely accept a package that was otherwise unexpected.

In another embodiment of the present invention, the receiver and transmitter accept and transmit signals via an encrypted Wi-Fi protocol.

In another embodiment of the present invention, the receiver and transmitter accept and transmit signals via a Bluetooth protocol.

In another embodiment of the present invention the tracking number on the parcel is replaced by a graphical element such as a Quick Response Code.

In another embodiment of the present invention, the door of the lock box can open and close automatically using a motor.
Therefore the present invention is a new and useful system for the selective receipt of delivered parcels utilizing a lock box having automated and remotely controlled features which has benefits over the prior art including allowing selective control of the receipt of delivered parcels, implementation of customizable parameters for accepting or declining receipt of said parcels, not requiring the parcel recipient to be present at time of delivery, contemporaneous and asynchronous remote authorization of parcel delivery, eliminating the need for missed deliveries and subsequent notification, eliminating travel to and from mail sorting centers and offices, real time electronic notifications to the recipient upon parcel delivery, automatic generation of tracking receipts as parcels are scanned, and secure locked storage of parcels while contained in the mailbox.

Although intended to be used similarly as a mailbox for domestic and business parcel delivery, it is envisioned that the present invention can be scaled for other courier models and to suit other purposes, for example the delivery of food orders, scientific specimens to labs, internal deliveries within offices and the like.

Further features and objectives of the present invention will become apparent form the following detailed description and the accompanying drawings.

### BRIEF DESCRIPTION OF THE DRAWINGS

FIG. 1 is a block diagram of an embodiment of a parcel delivery system according to the present invention;

FIG. 2 is a flowchart of a process that may be implemented in the parcel delivery system of FIG. 1;

FIG. 3 is a flowchart illustrating an initial passkey setup that may be implemented in the parcel delivery system of FIG. 1;

FIG. 4 is a flowchart illustrating an RF sensor assessment subroutine that may be implemented in the parcel delivery system of FIG. 1;

FIG. 5 is a flowchart illustrating a passcode creation subroutine that may be implemented in the parcel delivery system of FIG. 1;

FIG. 6 is a flowchart illustrating a database inquiry subroutine that may be implemented in the parcel delivery system of FIG. 1;

FIG. 7 is a flowchart illustrating an overall parcel delivery and notification process that may be implemented in the parcel delivery system of FIG. 1;

FIG. 8 is a flowchart illustrating an access determination subroutine that may be implemented in the parcel delivery system of FIG. 1;

FIG. 9 is a flowchart illustrating an optical sensor assessment subroutine that may be implemented in the parcel delivery system of FIG. 1;

FIG. 10 is a flowchart illustrating a door unlocking subroutine that may be implemented in the parcel delivery system of FIG. 1;

FIG. 11 is a flowchart illustrating a door locking subroutine that may be implemented in the parcel delivery system of FIG. 1; and

FIG. 12 is a flowchart illustrating an access denial subroutine that may be implemented in the parcel delivery system of FIG. 1.

### DETAILED DESCRIPTION OF THE INVENTION

As described above, the present invention provides a new and useful system for the selective receipt of delivered parcels utilizing a lock box having automated and remotely controlled features which has benefits over the prior art including allowing selective control of the receipt of delivered parcels, implementation of customizable parameters for accepting or declining receipt of said parcels, not requiring the parcel recipient to be present at time of delivery, contemporaneous and asynchronous remote authorization of parcel delivery, eliminating the need for missed deliveries and subsequent notification, eliminating travel to and from mail sorting centers and offices, real time electronic notifications to the recipient upon parcel delivery, automatic generation of tracking receipts as parcels are scanned, and secure locked storage of parcels while contained in the mailbox. Although intended to be used similarly as a mailbox for domestic and business parcel delivery, it is envisioned that the present invention can be scaled for other courier models and to suit other purposes, for example the delivery of food orders, scientific specimens to labs, internal deliveries within offices and the like.

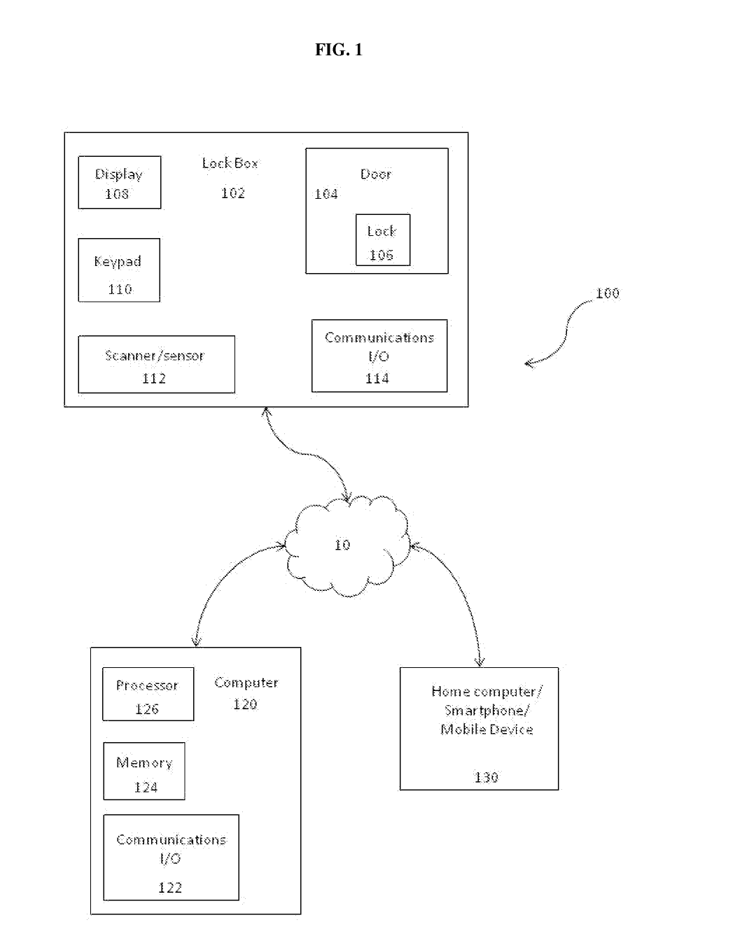

Referring now to the invention in more detail, in FIG. 1 there is shown a block diagram of an embodiment of a parcel delivery system 100 of the present invention. The system 100 includes a lock box 102 having a door 104 to provide access to storage space within the locker 102 and an electrically operated locking mechanism 106 to lock and unlock the door 104. The lock box 102 may be a mailbox, locker, or any other storage container. The lock box 102 is preferably secured to a fixed structure to prevent it from being removed without authorization. The lock box 102 may also include a display 108, on which messages may be displayed to a user, a keypad 110, to receive input from a user, and a scanner, sensor, or both, 112 to detect and decode parcel tracking numbers and passkeys. The display 108 may also comprise a touch screen allowing it both to present information and request input and to receive input using a virtual keypad, including entries that would otherwise be input through the keypad 110, which may then be an optional component of the lock box 102. The scanner 112 may read barcodes or quick response (QR) codes, or both, and the sensor may detect and read radio frequency (RFID) tags. The reference number “110” will be used herein to refer to both to a virtual keypad that is integrated with a touch display and to a physical keypad.

The lock box 102 may be a single box at a residence, a business, or one of an array of lock boxes, such as for a apartment or condominium complex or office building. In addition to being available for receiving mailed or shipped parcels, the lock box 102 may be used to make parcels available for pickup by a carrier as well as for the delivery or pick up of food, medical and scientific lab specimens, and documents and parcels being transferred between internal departments of an organization.

Using a communications port 114 through a network 10, the lock box 102 may communicate with other electronic devices, such as a computer or server 120, or a parcel recipient's personal computer, smartphone, or mobile device 130. The computer 120 includes at least a communications port 122, a memory or other non-transient storage medium 124 in which computer-readable coded instructions are stored, and a processor 126 configured to execute the instructions stored in the memory 124. In some embodiments, the computer 120 may be integrated into the lock box 102 while in other embodiments the computer 120 may be a remotely located computer or server configured to communicate with any number of lock boxes 102.

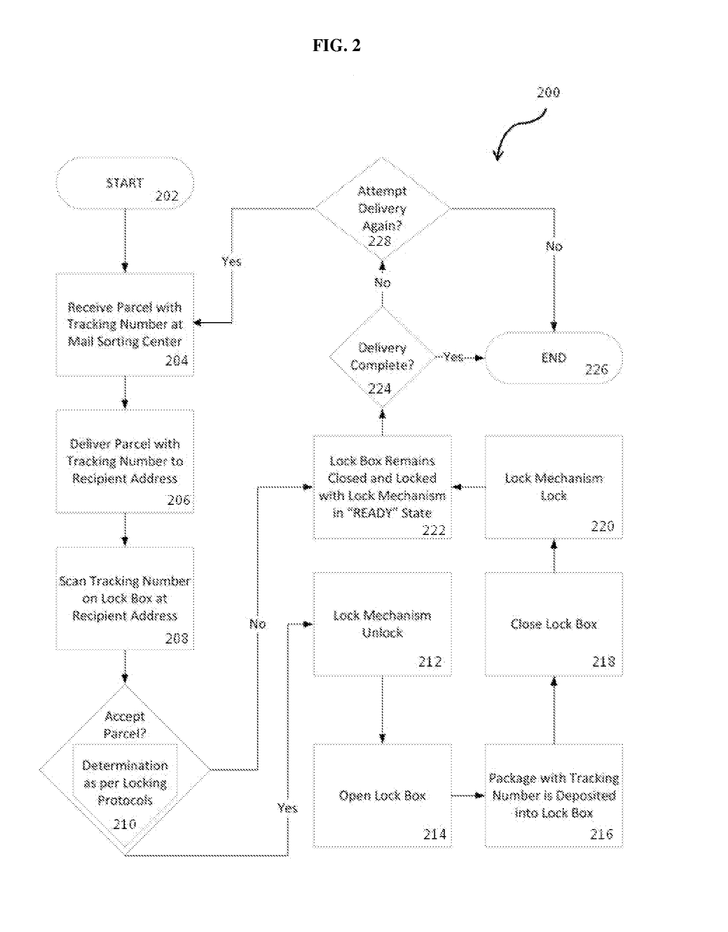

FIG. 2 is a flowchart of an overall process 200 that may be implemented in the parcel delivery system of FIG. 1. Referring both to FIG. 1 and FIG. 2, to begin (step 202) the process 200, a parcel that has been ordered by a recipient is received at a sorting center (step 204). The term “recipient” is used broadly herein to refer to any person who has authorization to administer the lock box 102. That person will typically, but not necessarily, be a person receives parcels at the lock box 102 or is otherwise the owner of the lock box 102. “Recipient” and “owner” are used interchangeably herein. The sorting center may be operated by any parcel carrier, such as the Postal Service, UPS, FedEx, DHL, etc. The parcel will have a tracking number encoded on the label, such as with a universal product barcode (UPC) or a quick response (QR) code or may have an RFID tag. The carrier transports the parcel to the recipient's address or lock box 102 location (step 206) and the tracking number on the parcel is scanned at the lock box 102. The lock box 102 determines whether it has been programmed to accept the parcel (step 210). If the recipient is expecting the parcel and has properly programmed the lock box 102, the locking mechanism 106 unlocks the door 104 (step 212), the box is opened (step 214), and the parcel is placed inside (step 216). The deliverer may then close the lock box 102 (step 218) and the lock re-locks (step 220), leaving the lock box 102 in a “ready” state (step 222). In some embodiments, the door 104 may be motorized and open and close automatically when it is unlocked or locked. Delivery may be indicated as being complete (step 224) and the process ends (step 226). At his or her convenience, the recipient may later unlock the door 104, such as by entering a code using the keypad 110 or using a master RF or physical key, and retrieve the parcel.

If the recipient has not programmed the lock box 102 to accept the parcel, the box 102 remains closed and in the ready state (step 222). Delivery may be indicated as not being complete (step 224) and a determination is made whether another attempt to the parcel should be made (step 228). If not, such as if multiple delivery attempts have failed, the process ends (step 226). Otherwise, the parcel is returned to the sorting center (step 204) and another attempt to deliver the parcel is made at a later time, repeating the process (beginning at step 206) until the parcel has been delivered or a determination is made not to attempt further deliveries.

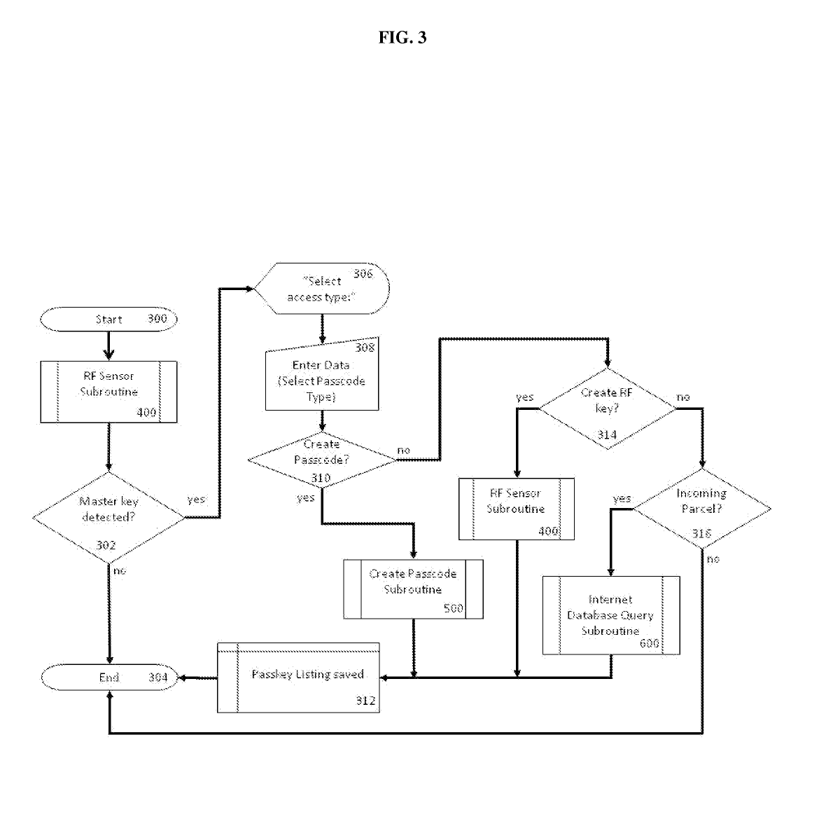

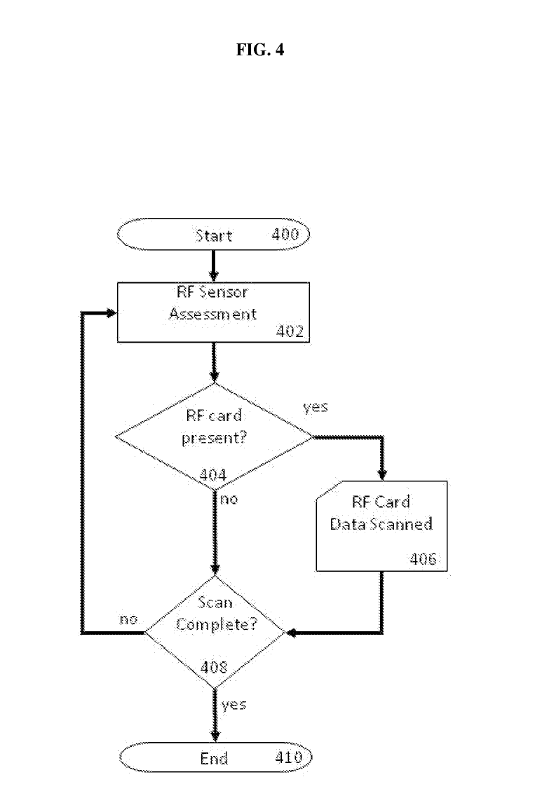

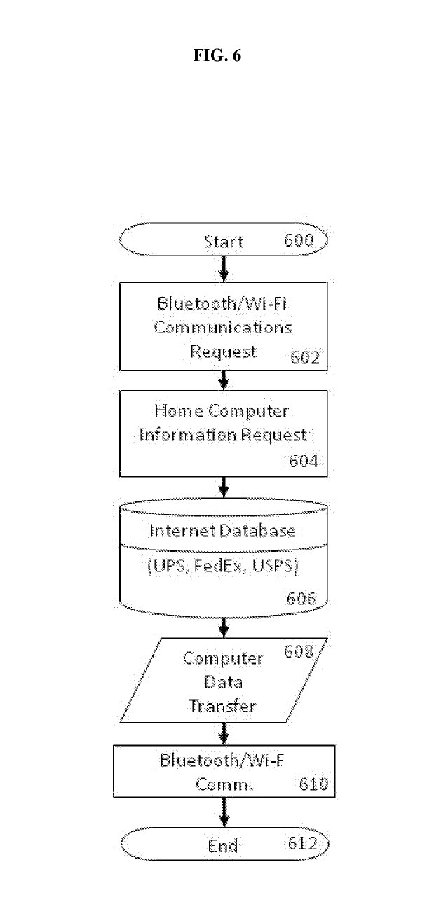

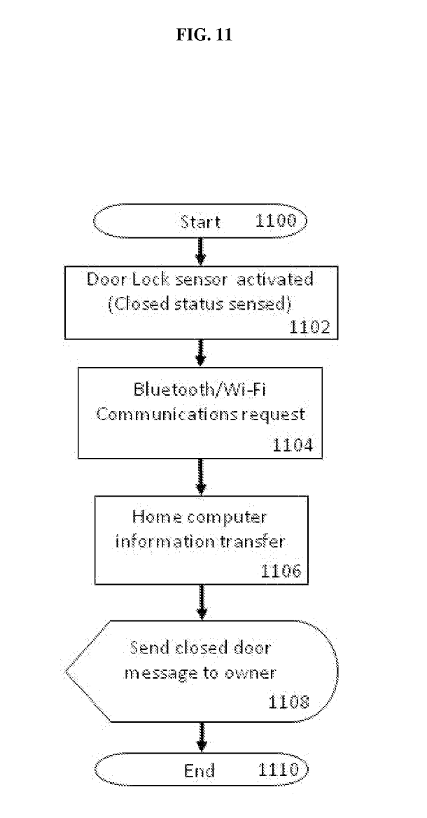

Flowcharts representing specific routines and subroutines that may be implemented as part of the process of FIG. 2 are illustrated in FIGS. 3-12. FIG. 3 is a flowchart illustrating an initial passkey setup 300 by the recipient. The routine 300 calls an RF sensor subroutine 400 (FIG. 4) to determine if an RF card is present (steps 402, 404). If so, the RF card is scanned (step 406) and a determination is made whether scanning is complete (step 408). If an RF card is not present (step 404), the determination is also made whether scanning is complete (step 408). If not, another pass is made through the subroutine 500. If scanning is complete, the subroutine 400\ends (step 410) and returns to FIG. 3.

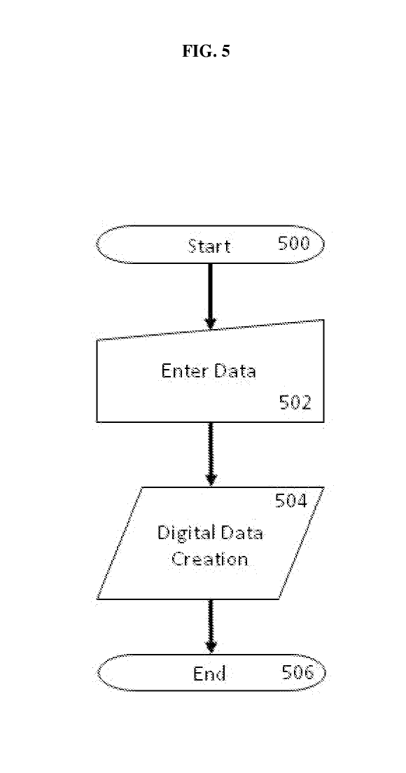

Following the RF card scan 400, a determination is made whether a master key has been detected (step 302), such as possessed by the recipient. If no such key is detected, the routine ends (step 304). Otherwise, the access types are presented on the display 108 on the lock box 102 (step 306) and the recipient uses the keypad 110 to make a selection (step 308). Among possible access types are to authorize a new passcode or to authorize a new RF key. If the recipient wishes to authorize a new passcode (step 310), a subroutine to create the passcode is called (step 500). Turning to the subroutine 500 illustrated in FIG. 5, the recipient uses the keypad 110 to enter a multi-character passcode (step 502). Preferably, the entered code will have many characters, which may consist of only digits (such as if the keypad 110 is a numerical keypad only) or be an alphanumeric code (if the keypad 110 accommodates such characters). After the code has been entered, the code is sent to the computer 120 (step 504), and the subroutine 500 ends (step 506) and returns to FIG. 3 where the code is stored (step 312) in a database or other appropriate memory in the computer 120.

Rather than create a passcode (step 310), the recipient may authorize a new RF key (step 314) and the RF sensor subroutine 400 is called again to scan a new RFID tag and store its identity with an authorization indicator. Upon completion, the created RF key is stored (step 312). If the recipient does not wish to create a passcode (step 310) or an RF key (step 314), the recipient an option indicating that he or she is expecting to receive a parcel (step 316). If so, another subroutine 600 is called and if not, the routine 300 ends (step 304).

The called subroutine 600 begins with a communications connection request 602 from the recipient's computer or other device 130. The communication may be through a Bluetooth connection, a wireless (WiFi), connection, or a wired network connection (step 604). Using the home computer or other electronic device 130, the recipient may access the parcel carrier's internet-accessible database (step 606) to obtain tracking information about the expected parcel (step 608). The communications connection may then terminate (step 610) and the subroutine 600 ends (step 612) and returns to FIG. 3 where the information is stored (step 312), thereby authorizing the lock box 102 to unlock the door 104 when the parcel arrives and is scanned and allow the parcel to be placed in the lock box 102. The routine 300 then ends (step 304).

The recipient may also program the lock box 102 in various other ways. The TABLE provides some examples of choices that may be presented on the display 108 for selection by the recipient and stored, such as with passkeys. The choices allow the lock box to be programmed to accept or decline delivery of parcels (by unlocking the door 104 or keeping it locked) under different specified conditions. The options in the TABLE allow the recipient to program the lock box 102 to always accept (or decline) delivery, to accept (or decline) delivery only from designated carriers, to accept (or decline) delivery only during specified times, or to accept (or decline) only a parcel with a specified tracking number. It will be appreciated that the options shown in the TABLE are not exhaustive and that other types of options may also be presented.

TABLE

| | Always | Carriers | Time Interval | Tracker Specific |
|---|---|---|---|---|
| Accept | Y/N | USPS, FedEx, | Start time/End | Enter Tracking |
| Delivery | | UPS, DHL | Time | Number |
| Decline | Y/N | USPS, FedEx, | Start time/End | Enter Tracking |
| Delivery | | UPS, DHL | Time | Number |

The recipient may also program the lock box 102 remotely using a home computer, smart phone, or other electronic device 130 through an application executing on the device 130 or through a website. Information and messages pertaining to the status of the lock box 102, confirmation of a delivery, requests for immediate authorization to access the lock box 102, or any other information and messages may similarly be transmitted to the recipient's device 130, such as by e-mail or text message. Thus, for example, a recipient may be able to authorize the delivery of an unexpected parcel.

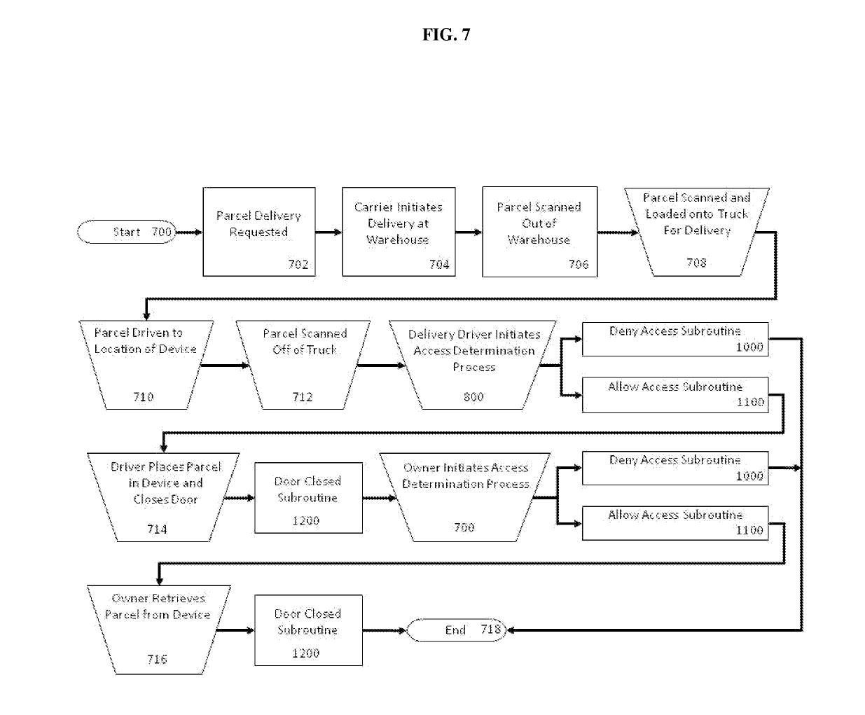

The flowchart of FIG. 7 illustrates an overall parcel delivery and notification process 700 that may be implemented in the parcel delivery system of FIG. 1. When a parcel to be delivered arrives at a carrier warehouse or distribution center (step 702), the carrier initiates its delivery process (704), scans the parcel's tracking code (step 706), and loads the parcel onto a delivery truck (step 708). The parcel is driven to the lock box 102 (step 710). When the truck arrives, the parcel is scanned off of the truck (step 712) and the driver initiates an access determination process 800.

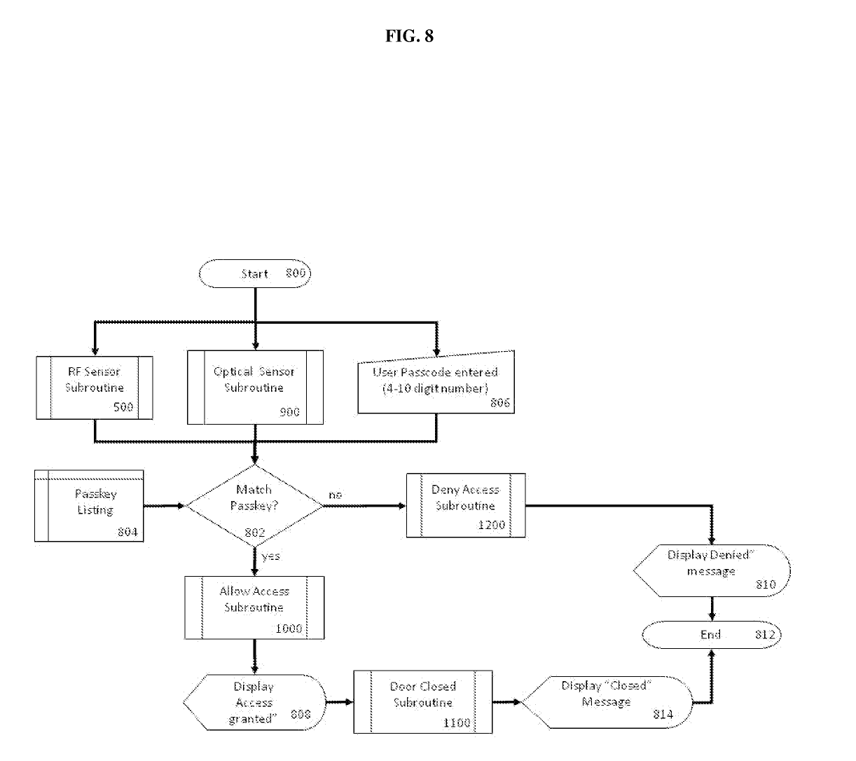

Referring to the process 800 illustrated in the flowchart of FIG. 8, how the driver accesses the lock box 102 depends on whether the parcel has an RFID tag, a printed optical code, or the driver will enter a previously-authorized passcode. If the parcel has an RFID tag, the subroutine 400 (FIG. 4) is called, the driver scans the tag using the lock box 102 sensor 112 (in this case, being an RF sensor), and a determination is made whether the scanned code matches the expected passkey (step 804) (previously programmed in the routine 300 of FIG. 3). Such a determination is made by accessing the passkey listing (step 806) that was previously stored (FIG. 3, step 312).

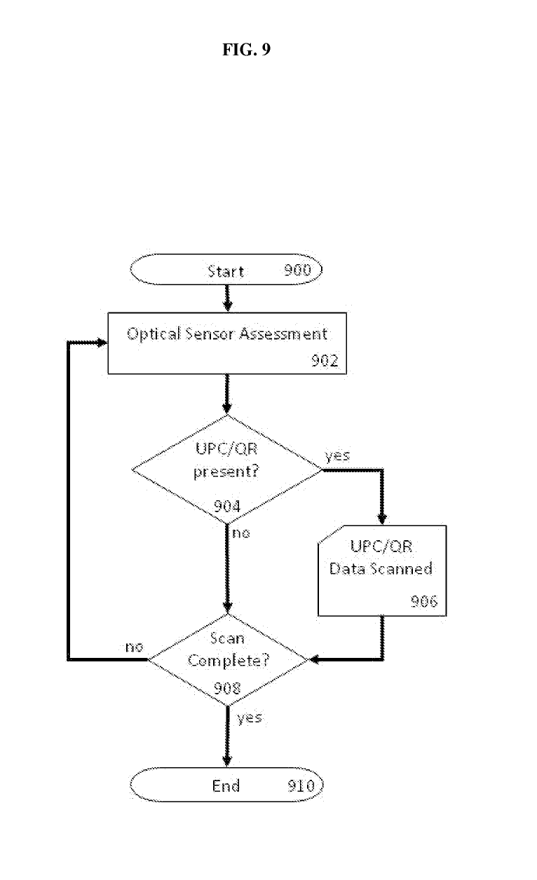

If the parcel has a printed optical code and the subroutine 900 (FIG. 9) is called. The driver scans the code (step 902) using the lock box 102 sensor 112 (in this case being a UPC or QR optical scanner) and a determination is made whether the scanned code is a valid code (step 904). If so, the code is read by the scanner (step 906). After the code is read, or if no authorized code is present, a determination is made as to whether the scan is complete (step 908). If not, the process is repeated (step 902) until the scan is complete (step 908) and the subroutine 900 ends (step 910) and returns to the access process 800. Again, a determination is made whether the scanned code matches the expected code (step 802). Such a determination is made by accessing the passkey listing (step 804).

If the parcel has neither an RFID tag or an optical code, the driver uses the keypad 110 to enter the passcode previously created by the recipient (FIG. 5) and provided to the driver (step 806). Again, a determination is made whether the entered code matches the expected code (step 802). Such a determination is made by accessing the passkey listing (step 804).

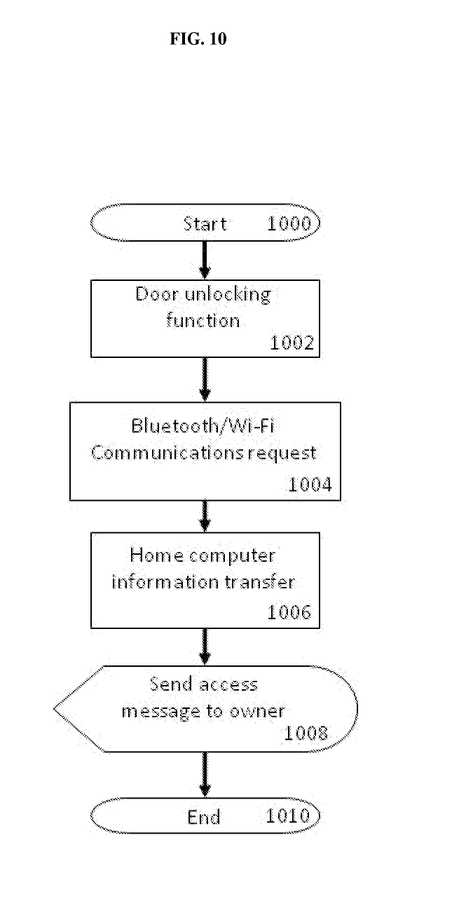

If the detected, scanned, or entered code matches the stored code (step 802), and if any other conditions programmed by the recipient, such as those in the TABLE, have been met, another subroutine 1000 (FIG. 10) is called to initiate a lock box door 104 unlocking function 1002. Having already confirmed the validity of the code scanned, sensed, or entered, the lock box 102 transmits (step 1004) a message through its communications port 114 to the recipient's 310 computer or other electronic device 130 (step 1006) that the door 104 is being opened and the parcel is being delivered (step 1008). In addition, the display 108 may display an appropriate message. The subroutine 1000 ends (step 1010) and returns to the process of FIG. 7.

After the parcel has been placed in the lock box (step 714), the driver closes the door to initiate another subroutine 1100. When the door 104 is closed, a sensor in the door 104 detects that the change in status from open to closed (step 1102), the lock 106 engages, and the lock box 102 transmits a message to the recipient that the door has been closed and locked (steps 1104-1108). In addition, the display 108 may display a message indicating that the door 102 is closed and locked. The subroutine 1000 ends (step 1110) and returns to the process of FIG. 7. In addition to being notified that the lock box door 10 has been closed, the absence of such a notice after the door 104 has been opened will alert the recipient to a possible problem.

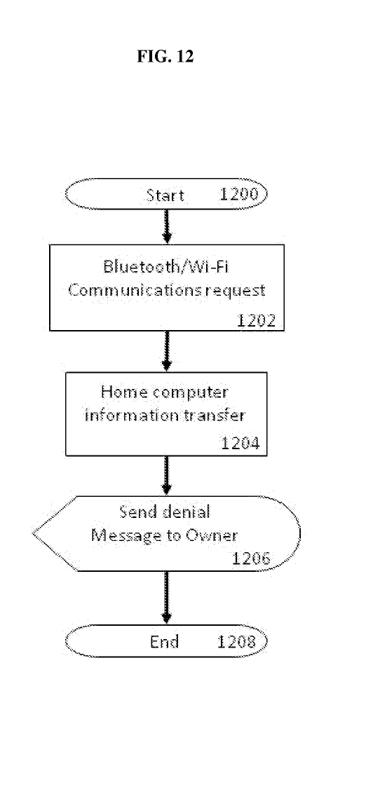

If the subroutine 800 determines that the code scanned, sensed, or entered is not a valid code, or if other programmed conditions have not been met, a subroutine 1200 (FIG. 12) begins. The lock box 102 transmits (step 1202) a message through its communications port 114 to the recipient's computer or other electronic device 130 (step 1204) that an attempt to open the door 104 was made but was unsuccessful (step 1206). The display 108 may also display a message indicating that access has been denied, whether from an unsuccessful delivery or an attempt to break into the lock box 102. The subroutine 1200 ends (step 1208) and returns to the process of FIG. 7.

After the door 104 has been closed and locked (step 1200), the recipient may initiate his or her own access to the lock box 102 to retrieve the parcel (step 700). The process by which the recipient is granted or denied access is the same as that for the deliverer (steps 1000 and 1200). If the recipient is successful and has retrieved the parcel (step 716), the recipient closes the door 104, initiating the door closing subroutine 1100. After the door 104 is closed and locked, the process ends (step 718) with the lock box 102 ready to receive another parcel.

The previously described versions of the present invention have many advantages, including and without limitation, the properties of i) allowing selective control of the receipt of delivered parcels, ii) implementation of customizable parameters for accepting or declining receipt of said parcels, iii) not requiring the parcel recipient to be present at time of delivery, iv) contemporaneous and asynchronous remote authorization of parcel delivery, v) eliminating the need for missed deliveries and subsequent notification, vi) eliminating travel to and from mail sorting centers and offices, vii) real time electronic notifications to the recipient upon parcel delivery, viii) automatic generation of tracking receipts as parcels are scanned, and ix) secure locked storage of parcels while contained in the mailbox. The device of the present invention is believed to accomplish all of the foregoing objectives. The invention does not require that all the advantageous features and all the advantages need to be incorporated into every embodiment of the invention.

Although the present invention has been described in considerable detail with reference to certain preferred versions thereof, other versions are possible. Therefore the spirit and scope of the appended claims should not be limited to the description of the preferred versions contained therein.

The reader's attention is directed to all papers and documents which are filed concurrently with this specification and which are open to public inspection with this specification, and the contents of all such papers and documents are incorporated herein by reference.

All the features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. As for “means for” elements, the applicant intends to encompass within the language any structure presently existing or developed in the future that performs the same function. The invention should therefore not be limited by the above described embodiment, method, and examples, but by all embodiments and methods within the scope and spirit of the invention.

What is claimed is:

1. A parcel delivery system, comprising:
a lock box, comprising:
a door providing access to a storage space;
an electrically operated locking mechanism configured to lock and unlock the door; and
a parcel scanning device configured to scan encoded parcel tracking numbers;
a processor; and
a memory configured to store computer-readable code executable by the processor, the computer-readable code comprising instructions for:
decoding an encoded parcel tracking number scanned by the parcel scanning device;
determining if the decoded tracking number is an authorized tracking number;
if the decoded tracking number is not an authorized tracking number:
declining to unlock the locking mechanism, whereby the door remains locked; and
transmitting a message to an owner of the lock box that access to the lock box was declined;
if the decoded tracking number is an authorized tracking number:
enabling the locking mechanism to unlock the door, whereby the door is allowed to be opened and the parcel placed into the storage space;
transmitting a message to the owner that the parcel has been placed in the lock box; and
after the door has been closed, enabling the locking mechanism to lock the door.

2. The parcel delivery system of claim 1, wherein the processor and memory are integrated into the lock box.

3. The parcel delivery system of claim 1, wherein:
the parcel scanning device comprises an RFID sensor; and
the instructions for decoding the encoded parcel tracking number scanned by the RFID sensor comprise instructions for detecting and reading an RFID tag associated with the parcel.

4. The parcel delivery system of claim 1, wherein:
the parcel scanning device comprises an optical code scanner; and
the instructions for decoding the encoded parcel tracking number scanned by the optical scanner comprise instructions for detecting and reading an optical code associated with the parcel.

5. The parcel delivery system of claim 1, wherein:
the lock box further comprises a keypad configured to receive an access passcode; and
the computer-readable code further comprises instructions for:
determining if the received passcode is an authorized passcode;
if the received passcode is not an authorized received passcode:
declining to unlock the locking mechanism, whereby the door remains locked; and
transmitting a message to the owner that access to the lock box was declined;
if the received passcode is an authorized received passcode:
enabling the locking mechanism to unlock the door, whereby the door is allowed to be opened;
transmitting a message to the owner that the lock box has been opened; and
after the door has been closed, enabling the locking mechanism to lock the door.

6. The parcel delivery system of claim 1, wherein the computer-readable code further comprises instructions for:
detecting a master RFID tag presented by the owner to the parcel scanning device;
receiving and storing a passcode input by the owner; and
enabling the locking mechanism to unlock the door when the passcode is entered by a parcel carrier, whereby the door is allowed to be opened and the parcel placed into the storage space.

7. The parcel delivery system of claim 1, wherein the computer-readable code further comprises instructions for:
detecting a master RFID tag presented by the owner to the parcel scanning device;
detecting a new RFID tag presented by the owner to the parcel scanning device;
storing the identity of the new RFID tag; and
enabling the locking mechanism to unlock the door when the new RFID tag is scanned by a parcel carrier, whereby the door is allowed to be opened and the parcel placed into the storage space.

8. The parcel delivery system of claim 1, wherein the computer-readable code further comprises instructions for:
detecting a master RFID tag presented by the owner to the parcel scanning device;
receiving and storing a parcel tracking number input by the owner; and
enabling the locking mechanism to unlock the door when the parcel tracking number is entered by a parcel carrier, whereby the door is allowed to be opened and the parcel placed into the storage space.

9. The parcel delivery system of claim 1, wherein the computer-readable code further comprises instructions for:
detecting a master RFID tag presented by the owner to the parcel scanning device;
receiving and storing a parcel tracking number input by the owner; and
enabling the locking mechanism to unlock the door when an optical code containing the parcel tracking number is scanned by a parcel carrier, whereby the door is allowed to be opened and the parcel placed into the storage space.

10. The parcel delivery system of claim 1, wherein the computer-readable code further comprises instructions for:
receiving a remote command from the owner; and
in response to the remote command, enabling the locking mechanism to unlock the door, whereby the door is allowed to be opened and the parcel placed into the storage space.

11. The parcel delivery system of claim 1, wherein the computer-readable code further comprises instructions for at least one of:
receiving and storing input entered by the owner to permit authorized access to the lock box at all times;
receiving and storing input entered by the owner to prevent access to the lock box at all times;
receiving and storing input entered by the owner permit authorized access to the lock box only by a selected carrier;
receiving and storing input entered by the owner prevent access to the lock box by a selected carrier;
receiving and storing input entered by the owner permit authorized access to the lock box only during a selected time interval; and
receiving and storing input entered by the owner prevent access to the lock box during a selected time interval.

12. An automated lock box, comprising:
a door providing access to a storage space;
an electrically operated locking mechanism configured to lock and unlock the door;
a parcel scanning device configured to scan encoded parcel tracking numbers;
a processor; and
a memory configured to store computer-readable code executable by the processor, the computer-readable code comprising instructions for:
decoding an encoded parcel tracking number scanned by the parcel scanning device;
determining if the decoded tracking number is an authorized tracking number; and
declining to unlock the locking mechanism, whereby the door remains locked if the decoded tracking number is not an authorized tracking number;
enabling the locking mechanism to unlock the door if the decoded tracking number is an authorized tracking number, whereby the door is allowed to be opened and the parcel placed into the storage space and, after the door has been closed, enabling the locking mechanism to lock the door.

13. The automated lock box of claim 12, wherein:
the parcel scanning device comprises an RFID sensor; and
the instructions for decoding the encoded parcel tracking number scanned by the RFID sensor comprise instructions for detecting and reading an RFID tag associated with the parcel.

14. The automated lock box of claim 12, wherein:
the parcel scanning device comprises an optical code scanner; and
the instructions for decoding the encoded parcel tracking number scanned by the optical scanner comprise instructions for detecting and reading an optical code associated with the parcel.

15. The automated lock box of claim 12, further comprising a keypad configured to receive an access passcode and the computer-readable code further comprising instructions for:
determining if the received passcode is an authorized passcode;
declining to unlock the locking mechanism if the received passcode is not an authorized received passcode, whereby the door remains locked; and
enabling the locking mechanism to unlock the door if the received passcode is an authorized received passcode, whereby the door is allowed to be opened;

16. The automated lock box of claim 12, wherein the computer-readable code further comprises instructions for:
detecting a master RFID tag presented by the owner to the parcel scanning device;
receiving and storing a passcode input by the owner; and
enabling the locking mechanism to unlock the door when the passcode is entered by a parcel carrier, whereby the door is allowed to be opened and the parcel placed into the storage space.

17. The automated lock box of claim 12, wherein the computer-readable code further comprises instructions for:
detecting a master RFID tag presented by the owner to the parcel scanning device;
detecting a new RFID tag presented by the owner to the parcel scanning device;
storing the identity of the new RFID tag; and
enabling the locking mechanism to unlock the door when the new RFID tag is scanned by a parcel carrier, whereby the door is allowed to be opened and the parcel placed into the storage space.

18. The automated lock box of claim 12, wherein the computer-readable code further comprises instructions for:
detecting a master RFID tag presented by the owner to the parcel scanning device;
receiving and storing a parcel tracking number input by the owner; and
enabling the locking mechanism to unlock the door when the parcel tracking number is entered by a parcel carrier, whereby the door is allowed to be opened and the parcel placed into the storage space.

19. The automated lock box of claim 12, wherein the computer-readable code further comprises instructions for:
detecting a master RFID tag presented by the owner to the parcel scanning device;
receiving and storing a parcel tracking number input by the owner; and
enabling the locking mechanism to unlock the door when an optical code containing the parcel tracking number is scanned by a parcel carrier, whereby the door is allowed to be opened and the parcel placed into the storage space.

20. The automated lock box of claim 12, wherein the computer-readable code further comprises instructions for enabling the locking mechanism to unlock the door in response to a remote command receive from the owner, whereby the door is allowed to be opened and the parcel placed into the storage space.

21. The automated lock box of claim 12, wherein the computer-readable code further comprises instructions for at least one of:
receiving and storing input entered by the owner to permit authorized access to the lock box at all times;
receiving and storing input entered by the owner to prevent access to the lock box at all times;
receiving and storing input entered by the owner permit authorized access to the lock box only by a selected carrier;
receiving and storing input entered by the owner prevent access to the lock box by a selected carrier;
receiving and storing input entered by the owner permit authorized access to the lock box only during a selected time interval; and
receiving and storing input entered by the owner prevent access to the lock box during a selected time interval.

22. The automated lock box of claim 12, wherein the computer-readable code further comprises instructions for transmitting messages to the owner indicating:
when the door has been opened;
when the door has been closed;
when an attempt to open the door is unsuccessful; and
when the parcel scanning device has scanned an encoded parcel tracking number.
